(19) United States
(12) Patent Application Publication
(10) Pub. No.: US 2007/0074605 A1
(43) Pub. Date: Apr. 5, 2007

(54) DISGUISED HOUSEHOLD TOOLS

(75) Inventor: Marilyn L. Smith, Los Angeles, CA (US)

Correspondence Address: PEARNE & GORDON LLP, 1801 EAST 9TH STREET, SUITE 1200, CLEVELAND, OH, 44114-3108, US

(73) Assignee: GANZ, Woodbridge (CA)

(21) Appl. No.: 11/537,832

(22) Filed: Oct. 2, 2006

Related U.S. Application Data
(60) Provisional application No. 60/722,344, filed on Sep. 30, 2005.

(51) Int. Cl. B25D 1/00; B25B 15/00

(52) U.S. Cl. 81/20; 81/436

(57) ABSTRACT

A hand tool includes an ornamental body, and a non-hidden tool head extending from the ornamental body. The ornamental body and non-hidden tool head together are configured to simulate an object that is not a hand tool. For example, the ornamental body and tool head together simulate a high-heeled shoe.

### STATEMENT OF RELATED APPLICATIONS

Benefit of U.S. Provisional Patent Application Ser. No. 60/722,344, filed Sep. 30, 2005, is hereby claimed and the disclosure incorporated herein by reference.

### FIELD OF THE INVENTION

The present invention relates to household tools, and more particularly to disguised hand tools and to tools that simulate household items.

### BACKGROUND OF THE INVENTION

Often persons living in apartments and sometimes houses do not own adequate tools to perform common household tasks, such as hanging picture frames and removing screws to replace batteries in toys or other devices. These persons often do not have a toolbox or other place for storing such tools as a hammer or a screwdriver. Moreover, such tools may be used only on rare occasions, and may therefore be difficult to locate when needed. Furthermore, handheld tools are typically not items that people display in plain view for their visitors and guests to see.

### SUMMARY OF THE INVENTION

Provided is a hand tool having an ornamental body and a non-hidden tool head that extends from the ornamental body. The ornamental body of the hand tool simulates an object that is not a hand tool, such as a decorative item. The ornamental body of the tool can conform to shapes such as an article of footwear, a high-heeled shoe, a sandal, a sneaker, an athletic shoe, a bowling shoe, a football cleat, a boot, snow shoes, slippers, ice skates, roller skates, clogs, platform shoes, loafers, moccasins, a knife, silverware, a centerpiece for a table, a picture frame, earrings, jewelry, artwork, pottery, a telephone, a remote control, a coaster, a brush, a comb, a rolling pin, a scooper, a teacup, a teapot, tweezers, a watering can, or various knick-knacks, so that the tool simulates such items by its appearance. The non-hidden tool head can include structure such as a head of a hammer, a tip for driving a screw, a pair of pliers, a wrench, a wire cutter, a tape measure, a pry bar, a level, a plane, a chisel, a brush, a scraper, a file, a punch, a pick, a nut driver, a wire stripper, a crimper, a hatchet, and a clamp.

Further provided is a hammer that simulates a shoe. The hammer includes a handle having a shape that simulates a shoe upper and a shoe sole. A head for the hammer has a shape that simulates a shoe heel, where the head includes a first end face that is attached to the handle and a second end face forming a flat metal striking surface. The shoe upper can be a simulated shoe strap and the hammer can be configured to simulate a sandal. The heel can be a high-heel and the hammer can be configured to simulate a high-heeled shoe. The first end face may be smaller than the second end face.

Further provided is a screwdriver that simulates a knife. The screwdriver includes a handle and a shaft. The shaft includes a proximal end connected to the handle, a distal end forming a screwdriver tip for operatively engaging a screw, a top planar surface extending between the proximal end and the distal end in a longitudinal direction, a bottom surface extending between the proximal end and the distal end in a longitudinal direction, and a left side surface and a right side surface extending between the proximal end and the distal end in a longitudinal direction. The top surface, the bottom surface, the left side surface, and the right side surface form a rectangular cross-section in a lateral direction. The cross-section of the distal end is adapted to engage the slot of a screw. In another embodiment, the left side surface and the right side surface are at least slightly tapered near the distal end to form a cross-section area at the screwdriver tip that is less than the rectangular cross-section area of the shaft. In an embodiment, the top surface and the bottom surface of the shaft each lack an effective cutting edge. The handle and the shaft together are configured to substantially conform to a dull knife so that the screwdriver simulates the dull knife. The thickness of the shaft along the top surface can be substantially the same as the thickness of the shaft along the bottom surface.

### BRIEF DESCRIPTION OF THE DRAWINGS

FIG. 1 is a perspective view of a hammer according to a first embodiment of the present invention;

FIG. 2 is a view showing the hammer of FIG. 1 being used to strike a nail;

FIG. 3 is a side view of a screwdriver according to an embodiment of the present invention;

FIG. 3A is a partial side view of a screwdriver according to an embodiment of the present invention;

FIG. 3B is an end view of a shaft of the screwdriver;

FIG. 4 is a view showing the screwdriver of FIG. 3 being used to tighten or loosen a screw;

FIG. 5 is a perspective view of a combination hammer and container disguised as a high-heeled shoe.

### DETAILED DESCRIPTION OF THE INVENTION

The present invention provides a functional household tool, which is disguised as a decorative, nonfunctional, and/or another unrelated item. The tool would normally be displayed in plain view as a small ornamental item, such as a knick-knack on a shelf, for example. Because the tool simulates an ornamental item, an observer would ordinarily not perceive the item's usefulness as a tool. The observer would ordinarily perceive only a generally decorative and/or non-functional ornamental item. The disguised tool has an exposed or non-hidden tool head extending from an ornamental body. However, because the tool simulates another unrelated item, the tool head would ordinarily not be perceived as such by an unknowing observer.

Displaying objects as decorative or ornamental items includes, for example, exhibiting artwork, pottery, silverware, or various knick-knacks so that the items can be readily accessed and viewed by others. Typically, decorative or ornamental objects such as pieces of artwork, pottery, and knick-knacks are attractive to look at, but serve a limited functional purpose. For example, a piece of pottery may be useful as a vase, but not as a hammer or other household tool. The present invention provides a decorative or ornamental object that can be displayed daily and which is functional as a disguised household tool, for example, a hand tool. Examples of such tools include hammers, screwdrivers, scissors, pairs of pliers, wrenches, containers, cutters, for example, box cutters and wire cutters, tape measures, pry bars, levels, planes, chisels, brushes, scrapers, files, punches, picks, nut drivers, wire strippers, crimpers and clamps. The ornamental body of the tool can conform to shapes such as an article of footwear, a high-heeled shoe, a sandal, a sneaker, an athletic shoe, a bowling shoe, a football cleat, a boot, snow shoes, slippers, ice skates, roller skates, clogs, platform shoes, loafers, moccasins, a knife, silverware, a centerpiece for a table, a picture frame, earrings, jewelry, artwork, pottery, a telephone, a remote control, a coaster, a brush, a comb, a rolling pin, a scooper, a teacup, a teapot, tweezers, a watering can, or various knick-knacks, so that the tool simulates such items by its appearance.

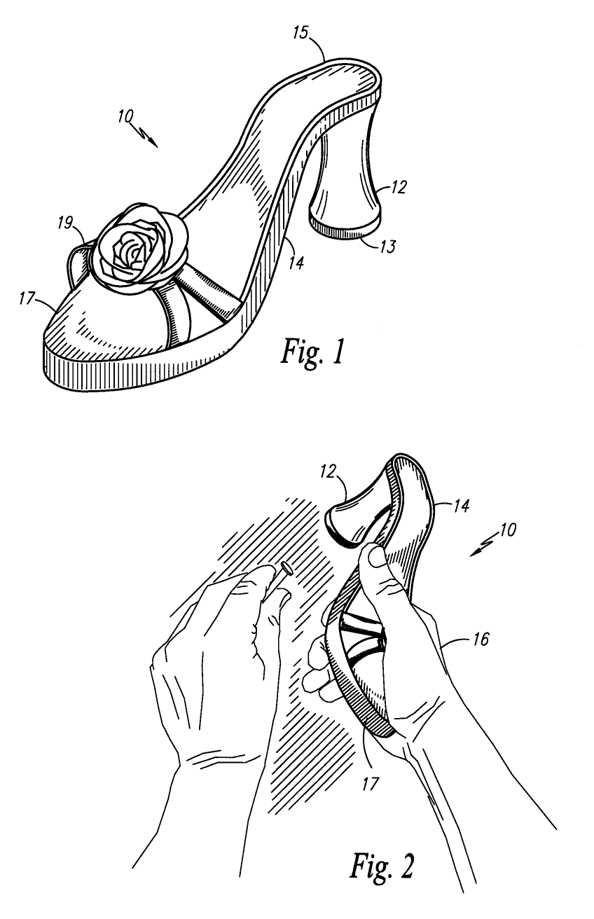

As shown in FIGS. 1 and 2, according to an example embodiment of the present invention, a hammer 10 can be fashioned to look like an article of footwear, such as a woman's shoe. The structure that appears to be the heel of the shoe can be the head 12 of the hammer 10 and can be constructed of a heavy material to provide an effective striking surface, such as steel or cast iron, for example. Other suitable materials can be used, such as hard rubber. In one example embodiment, the metal head 12 has a weight of less than 6 ounces, and more preferably a weight of approximately 3.3 ounces, and the hammer including the metal head 12 has a total weight of less than 12 ounces, and more preferably, approximately 6.3 ounces.

The shape of the head 12 can be generally cylindrical with varying amounts of curvature to further disguise the shoe's functional purpose as a hammer. The shoe can appear to be a typical high-heeled shoe. The shoe can also appear to have an oversized heel that is disproportionately large when compared to other portions of the shoe, such as the shoe upper and sole. An oversized heel, especially one having a broad flat bottom surface 13, may provide a more effective striking surface than a smaller heel.

The handle 14 of the hammer 10 is comprised of a toe portion 17 and a rear portion 15. The head 12 of the hammer 10 in this embodiment includes a first end face that is attached to a handle 14 of the hammer near the rear portion 15 and the head 12 contains a second end face, the flat bottom surface 13, that is used to strike a nail or other object. The first end face of the heel can be smaller than the flat bottom surface 13 that strikes a nail or other object. The handle 14 of the hammer 10 can be at its peak height where it is connected with the head 12 at the rear portion 15 of the sole. The head 12 can have varying dimensions causing the object to simulate either a low-heeled shoe or a high-heeled shoe. The handle 14 angles downward from the rear portion 15 of the sole towards a toe portion 17 of the sole. To further ensure that the average observer does not realize that the simulated shoe is actually a functional hammer, handle 14 of the hammer includes a simulated shoe upper comprising a shoe strap 19. The shoe strap 19 can contain any type of ornamental design, such as a depiction or simulation of a flower as in FIG. 1. The shoe strap 19 is provided on the top side of the toe portion 17 of the shoe. The shoe strap 19 can be provided to cause the average observer to believe the hammer 10 is a depiction of a shoe. In one embodiment, the shoe strap 19 can be comprised of the same material as the handle of the shoe 14. Furthermore, the handle 14 of the hammer can contain any type of ornamental design, such as texture designs or color schemes, to further simulate a shoe.

As best seen in FIG. 2, the hammer 10 can be sized to be much smaller than a typical shoe, allowing it to be grasped in the palm of a user having an averaged sized hand. In use, the handle 14 of the hammer 10 can be gripped in one hand 16 of the user and used like a conventional hammer to strike a nail 18. More specifically, the hand 16 of the user can grip the hammer 10 at the toe portion 17 of the shoe. The underside of the shoe, which is part of the handle 14 of the hammer 10, has a smooth surface that slopes upwards from the toe portion 17 to the rear portion 15. The smooth, sloped surface allows the user to comfortably grip the hammer 10. In this embodiment, the shoe strap 19 can be comprised of a rigid material that does not deform in response to a user grasping the hammer 10. The shoe strap 19 can provide additional thickness and comfort to a user grasping the hammer 10. In another embodiment, the hammer 10 further comprises a storage compartment, in which the handle 14 forms a lid for the storage compartment. When not in use, the hammer 10 can be stored in plain view on a shelf or other location as a decorative item. As a result, the hammer 10 can be quickly located by the user, without the need to search through drawers, cabinets, or a toolbox.

In one embodiment, the flat bottom surface 13 has a larger cross-section area than the other portions of the head 12. As the head 12 has a curvature, the head 12 has gradually less of a cross-sectional area while approaching the middle of the head 12. The head 12 can then have a gradually increasing cross-section area between the middle of the head 12 and the first end face attached to the rear portion 15 of the sole. The head 12 can have a larger cross-section area near the first end face that is similar in size to the cross-section area of the bottom or striking surface 13.

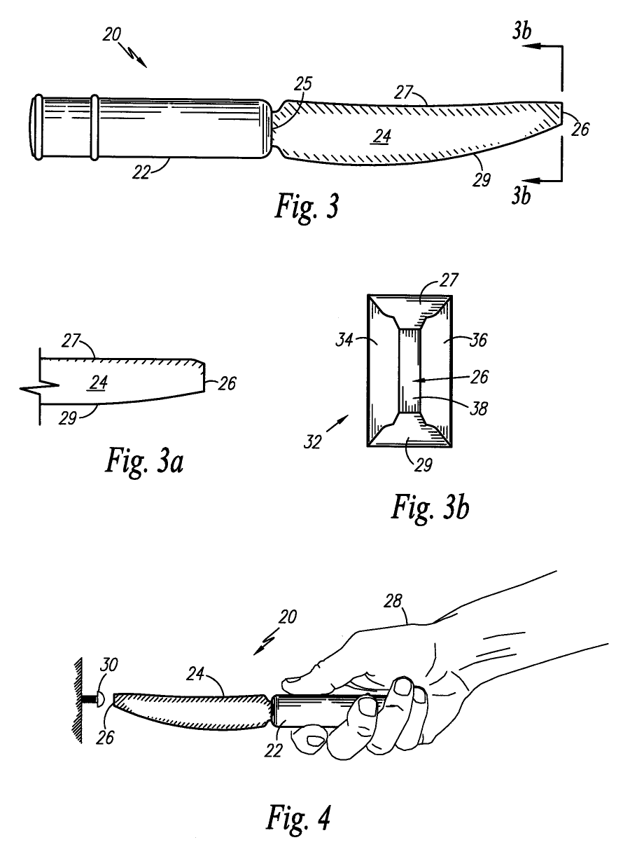

As shown in FIGS. 3 and 4, according to a second embodiment of the present invention, a screwdriver 20 simulates a knife having a decorative handle 22. A shaft 24 of the screwdriver 20 simulates a knife blade. The decorative handle 22 can include decorative or ornamental textures, colors, and/or designs. Portions of the decorative handle 22 can contain different ornamentation than other portions of the handle 22, to further disguise the screwdriver 20 as a knife. The shaft 24, simulating an elongated blade, is connected to the handle 22. The shaft 24 includes a proximal end 25 connected to the handle 22, a distal end forming a screwdriver tip 26 for operatively engaging a screw, a top surface 27 extending between the proximal end 25 and the distal end 26, a bottom surface 29 extending between the proximal end 25 and the distal end 26, and a left side surface 34 and a right side surface 36 that extend between the proximal end 25 and the distal end 26 in a longitudinal direction. The top surface 27, the bottom surface 29, the left side surface 34, and the right side surface 36 form a rectangular cross-section in a lateral direction. The top surface 27 of the shaft 24 is substantially straight in a longitudinal direction or is slightly curved. The bottom surface 29 is gently curved. The bottom surface 29 is closest to the top surface at the distal end 26 in this embodiment.

The shaft 24 of the screwdriver 20 can be wider and thicker at the proximal end 25 than the distal end 26, where the flat blade screwdriver tip 26 is located. Along the length of the shaft 24, the thickness of the shaft 24 at its top surface 27 can be substantially the same as the thickness of the shaft 24 at its bottom surface 29. Neither the top surface 27 nor bottom surface 29 of the shaft 24 provide an effective cutting edge, as would typically be found on a functional knife. The handle 22 and the shaft 24 together are configured to substantially conform to a dull knife so that the screwdriver simulates the dull knife.

FIG. 3A shows the distal end 26 of the shaft 24 in detail. The top surface 27 of the shaft has a slight downward taper at the distal end 26. The bottom surface 29 of the shaft 24 has an upward curve toward the distal end 26, to better simulate a blade. The distal end 26 of the shaft 24 is not as wide as other portions of the shaft because of the downward taper of the top surface 27 and upward curve of the bottom surface 29. A cross-sectional view of the distal end 26 can be seen in FIG. 3B. It is to be appreciated the size and shape of the distal end can be adapted to conform to screw heads of various sizes.

The four sides of the shaft 24 include the top surface 27, the bottom surface 29, the left side surface 34, and the right side surface 36 that each extend between the proximal end and the distal end in a longitudinal direction. These four sides of the shaft 24 extend longitudinally from the handle 22 and the four sides form a cross-section 32 that is rectangular in shape, as seen in FIG. 3B. In the embodiment shown in FIG. 3B, the left side surface 34 and the right side surface 36 are at least slightly tapered near the distal end 26 of the shaft 24. The tapering forms a cross-section area 38 at the screwdriver tip 26 that is less than the rectangular cross-section area 32 of other portions of the shaft 24. The cross-section area 38 is adapted to engage the slot of a screw. In other embodiments, other configurations may be used that still simulate a knife involving different curvatures of the bottom surface 29, the absence of curvature, as well as different tapering arrangements of the distal end 26. FIG. 3B shows an embodiment in which the handle 22 has a thickness that is less than or equal to the cross-section area 32 of the shaft 24. It is to be appreciated that in an alternative embodiment, the handle 22 can have a thickness larger than the cross-section area 32 of the shaft 24.

In use, as shown in FIG. 4, the handle 22 of the screwdriver 20 can be gripped in one hand 28 of a user and used like a conventional screwdriver to drive a screw 30. Like the hammer 10 of the first embodiment, the screwdriver 20 can be conveniently stored in view on a shelf or other location as a decorative item when not in use. As a result, the screwdriver 20 can be quickly located by the user, without the need to search through drawers or cabinets.

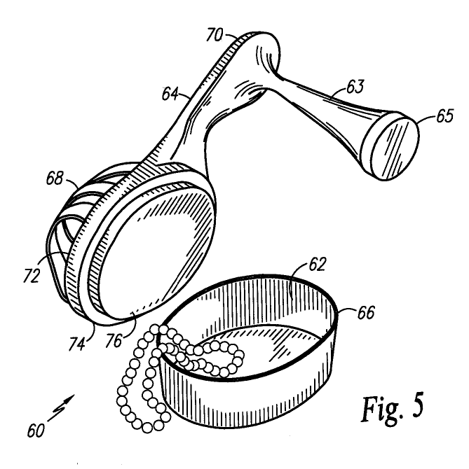

FIG. 5 shows an example embodiment in which a combined hammer and container 60 is fashioned to look like a woman's high-heeled shoe. An upper sole 64 of a shoe is connected to both a heel 63 and a lower sole 62 of the shoe. The heel 63 in this example embodiment contains a flat bottom surface 65 that can be used to strike a nail or other object. The shape of the heel can be generally cylindrical with varying amounts of curvature to further disguise the shoe's functional purpose as a hammer. The top of the heel is connected to a bottom portion of the upper sole 64. The shoe can appear to be a typical high-heeled shoe. The lower sole 62 forms a “bowl” of the container portion. When placed onto the lower sole 62, the upper sole 64 of the shoe extends from the top edge 66 of the lower sole 62 and forms a lid for the container 60. The upper sole 64 is detachable from the lower sole 62 to reveal the contents of the container 60. It is to be appreciated that items such as jewelry, valuable objects, or other items may be stored in the container 60 and will still be hidden from the view of the average observer. The upper sole 64 and the lower sole 62 can appear to an observer to be formed from one continuous piece of material. It is to be appreciated that this design reduces the chances of the average observer noticing that the upper sole 64 is detachable from the lower sole 62.

When not in use, the hammer and container 60 can be stored in view on a shelf or other location as a decorative item. As a result, the hammer and container 60 can be quickly located by the user, without the need to search through drawers or cabinets.

To further ensure that the average observer does not realize that the shoe is a hammer and container 60, a shoe upper comprising a shoe strap 68 or an upper forming closed footwear is provided. The shoe strap 68 is connected at at least two points to the upper sole 64. The shoe strap 68 can contain any type of ornamental design. The shoe strap 68 also functions as a handle for detaching the upper sole 64 from the lower sole 62. In the example embodiment, the lower sole 62 is one piece that supports only a toe portion 72 of the body 64 of the shoe. The heel 63 supports a heel portion 70 of the upper sole 64.

In one embodiment, the top edge 66 of the lower sole 62 supports an outer edge 74 of the bottom of the upper sole 64 of the shoe. An inner edge 76 of the bottom of the upper sole 64 can extend into the container 60. By extending into the container 60, the inner edge 76 makes it easier for a user to quickly place the upper sole 64 onto the lower sole 62. The inner edge 76 also helps to form a secure connection between the upper sole 64 and the lower sole 62. The secure connection occurs due to the inner edge 76 causing the upper sole 64 of the shoe to fit on the lower sole 62 in only one exact position and limits any possible sliding or displacement of the upper sole 64 from the lower sole 62.

Alternatively, according to the present invention, other handheld tools, for example, scissors, pairs of pliers, wrenches, containers, cutters, for example, box cutters and wire cutters, tape measures, pry bars, levels, planes, chisels, brushes, scrapers, files, punches, picks, nut drivers, wire strippers, crimpers and clamps and the like, can be designed to appear as decorative, nonfunctional and/or unrelated objects for discreet storage in plain view. Furthermore, the tool can have any functional purpose for application in a living environment, such as inserting a nail, securing a screw, cutting another object, gripping another object, or securing another object. It is to be appreciated that a living environment refers to any house, apartment, motorhome, or other habitable space. The present invention also can contain multiple functional tools in a single object.

It should be evident that this disclosure is by way of example and that various changes may be made by adding, modifying or eliminating details without departing from the fair scope of the teaching contained in this disclosure. The invention is therefore not limited to particular details of this disclosure.

What is claimed is:

1. A hand tool, comprising:
an ornamental body; and
a non-hidden tool head extending from the ornamental body; wherein the ornamental body and non-hidden tool head together are configured to simulate an object that is not a hand tool.

2. A hand tool as set forth in claim 1, wherein the ornamental body and the non-hidden tool head simulate an article of footwear.

3. A hand tool as set forth in claim 1, wherein the ornamental body and non-hidden tool head simulate a high-heeled shoe.

4. A hand tool as set forth in claim 3, wherein the tool head includes a head of a hammer.

5. A hand tool as set forth in claim 1, wherein the ornamental body and non-hidden tool head simulate a sandal.

6. A hand tool as set forth in claim 1, wherein the tool head includes a head of a hammer.

7. A hand tool as set forth in claim 1, wherein the tool head includes a tip for driving a screw.

8. A hand tool as set forth in claim 1, wherein the hand tool is one of a hammer, a screwdriver, a pair of scissors, a pair of pliers, a wrench, a wire cutter, tape measure, a pry bar, a level, a plane, a chisel, a brush, a scraper, a file, a punch, a pick, a nut driver, a wire stripper, a crimper and a clamp.

9. A hammer, comprising:
a handle having a shape that simulates a shoe upper and a shoe sole; and
a head for the hammer having another shape that simulates a shoe heel, wherein the head includes a first end face that is attached to the handle and a second end face forming a flat metal striking surface, and further wherein the hammer is configured to simulates a shoe.

10. A hammer as set forth in claim 9, wherein the shoe upper is a simulated shoe strap and the hammer is configured to simulate a sandal.

11. A hammer as set forth in claim 9, wherein the heel is a high-heel and the hammer is configured to simulate a high-heeled shoe.

12. A hammer as set forth in claim 11, wherein the first end face is smaller than the second end face.

13. A screwdriver, comprising:
a handle; and
a shaft, the shaft including:
a proximal end connected to the handle;
a distal end forming a screwdriver tip for operatively engaging a screw;
a top planar surface extending between the proximal end and the distal end in a longitudinal direction;
a bottom surface extending between the proximal end and the distal end in a longitudinal direction;
a left side surface extending between the proximal end and the distal end in a longitudinal direction; and
a right side surface extending between the proximal end and the distal end in a longitudinal direction, wherein the top surface, the bottom surface, the left side surface, and the right side surface form a rectangular cross-section in a lateral direction, and further wherein the cross-section of the distal end is adapted to engage the slot of a screw, and further wherein the screwdriver simulates a knife.

14. A screwdriver as set forth in claim 13, wherein the left side surface and the right side surface are at least slightly tapered near the distal end to form a cross-section area at the screwdriver tip that is less than the rectangular cross-section area of the shaft.

15. A screwdriver as set forth in claim 13, wherein the top surface and the bottom surface each lack an effective cutting edge, and further wherein the handle and the shaft together are configured to substantially conform to a dull knife so that the screwdriver simulates a dull knife.

16. A screwdriver as set forth in claim 1, wherein the shaft has a thickness, and further wherein the thickness of the shaft along the top surface is substantially the same as the thickness of the shaft along the bottom surface.
